(19) United States
(12) Patent Application Publication
(10) Pub. No.: US 2026/0313165 A1
(43) Pub. Date: Oct. 8, 2026

(54) TECHNIQUES FOR DETECTING REFERENCE FRAME MISMATCHES IN ENCODED VIDEO STREAMS

(71) Applicant: NETFLIX, INC., Los Gatos, CA (US)

(72) Inventor: Xiaomei LIU, Cupertino, CA (US)

(21) Appl. No.: 19/172,568

(22) Filed: Apr. 7, 2025

(51) Int. Cl. H04N 19/65; H04N 19/14; H04N 21/2187; H04N 21/234

(52) U.S. Cl. CPC H04N 19/65; H04N 19/14; H04N 21/2187; H04N 21/23418

(57) ABSTRACT

In various embodiments, a computer-implemented method for mitigating reference frame mismatches in encoded video streams includes generating first metadata that indicates a first frame location associated with a first encoded video stream, determining that the first encoded video stream includes a non-reference frame at the first frame location, and creating system metrics for debugging and error notifications.

### BACKGROUND

### Field of the Various Embodiments

Embodiments of the present disclosure relate generally to computer science and video processing and, more specifically, to techniques for detecting reference frame mismatches in encoded video streams.

### Description of the Related Art

Modern streaming services typically implement cloud-based networks of computer systems to stream audiovisual content associated with media titles to endpoint devices. An architecture of a given cloud-based network often includes one or more content servers, one or more encoding pipelines, one or more packagers, one or more origin servers, and a content delivery network (CDN). In such an architecture, the content servers store raw audiovisual content and distribute that content to the encoding pipelines. The encoding pipelines encode the raw audiovisual content into a compressed format and transmit encoded audiovisual content to the packagers. The packagers prepare the encoded audiovisual content for playback on various downstream endpoint devices and provide the packaged audiovisual content to the origin servers. The origin servers store the packaged audiovisual content and distribute that content to the CDN. The CDN includes a hierarchy of geographically distributed nodes that distribute the content to nearby endpoint devices. A given endpoint device can decode the received audiovisual content and then output the decoded audiovisual content for display to a user.

Encoded audiovisual content typically includes one or more encoded video streams. A given encoded video stream usually includes reference frames that can be decoded independently of other frames and non-reference frames that can only be decoded based on a specific reference frame. Under many streaming configurations, one or more advertisements can be seamlessly spliced into the primary content associated with a video stream by inserting a reference frame that transitions from the primary content into the advertisement(s). A reference frame associated with the primary content is also typically needed in order to seamlessly transition from the advertisement(s) back to the primary content. In streaming configurations that implement a server guided ads insertion (SGAI) design, additional advertisement signaling is provided to indicate, with frame accuracy, precise locations in the primary content where transitions into advertisements can occur and precise locations where transitions back to the primary content can occur. A common advertisement signaling technique involves introducing markers into a timed metadata track and configuring the markers to indicate the locations of specific reference frames where the insertion of advertisements can occur.

One drawback of the approach described above is that advertisement signaling can occasionally indicate a location in the video stream that is not associated with a reference frame and that potentially corresponds to a non-reference frame.

Advertisements generally cannot be inserted at non-reference frame locations without introducing disruptive visual artifacts. Consequently, advertisement signaling that erroneously corresponds to a non-reference frame can compromise seamless transitions between primary content and advertisements.

As the foregoing illustrates, what is needed in the art is a more effective technique for detecting mismatches between advertisement signaling and reference frames in encoded video streams.

### SUMMARY

In various embodiments, a computer-implemented method for mitigating reference frame mismatches in encoded video streams includes generating first metadata that indicates a first frame location associated with a first encoded video stream, determining that the first encoded video stream includes a non-reference frame at the first frame location, and generating one or more metrics that describe a defect associated with at least a portion of the encoded video stream.

At least one technical advantage of the disclosed techniques relative to the prior art is that mismatches and/or misalignments between advertisement signaling and reference frames can be detected and mitigated, thereby enabling situations to be avoided where such mismatches complicate or prevent transitioning between advertisements and primary content. Another technical advantage of the disclosed techniques is that detecting such mismatches downstream of the one or more encoders allows encoder defects to be addressed by the encoders expeditiously.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments; and

FIG. 4 is a more detailed block diagram of the endpoint device of FIG. 1, according to various embodiments;

FIG. 5 illustrates a network infrastructure that can be used to distribute audiovisual content to the endpoint devices of FIG. 1, according to various embodiments;

FIG. 6 illustrates how the packager of FIG. 5 detects reference frame mismatches in encoded video streams, according to various embodiments; and

FIG. 7 is a flow diagram of method steps for mitigating reference frame mismatches in encoded video streams, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Modern streaming services typically implement cloud-based networks of computer systems to stream audiovisual content associated with media titles to endpoint devices. Encoded audiovisual content typically includes one or more encoded video streams. A given encoded video stream usually includes reference frames that can be decoded independently of other frames and non-reference frames that can only be decoded based on a specific reference frame. In many streaming configurations, one or more advertisements can be seamlessly spliced into the primary content associated with a video stream by inserting a reference frame that transitions from the primary content into the advertisement(s). A reference frame associated with the primary content is also typically needed in order to seamlessly transition from the advertisement(s) back to the primary content. In streaming configurations that implement a server guided ads insertion (SGAI) design, additional advertisement signaling is provided that indicates, with frame accuracy, precise locations in the primary content where transitions into advertisements can occur and precise locations where transitions back to the primary content can occur. A common advertisement signaling technique involves introducing markers into the timed metadata track and configuring these markers to indicate the location of specific reference frames where the insertion of advertisements can occur. For example, Society of Cable Telecommunications Engineers (SCTE) 35 markers are often used for advertisement signaling.

One drawback of the approach described above is that advertisement signaling can occasionally indicate a location in the video stream that is not associated with a reference frame and that potentially corresponds to a non-reference frame. Such situations can occur when separate video streams become misaligned due to, for example and without limitation, encoder defects, among other issues. Advertisements generally cannot be inserted at non-reference frame locations without introducing disruptive visual artifacts. Consequently, advertisement signaling that erroneously corresponds to a non-reference frame can complicate or prevent seamless transitions between primary content and advertisements.

To address these issues, one or more packager instances are coupled downstream of one or more encoder instances and are configured to detect mismatches and/or misalignment between advertisement signaling and reference frames included in segments of encoded video frames. Each packager instance is coupled to a shared datastore and is configured to cache metadata that is associated with received advertisement signaling and metadata associated with reference frames in the shared datastore during processing of a given segment. During processing of a subsequent segment, a given packager instance can inspect the shared datastore to determine whether advertisement signaling received during processing of the previous segment correctly indicates a reference frame included in the previous segment or, alternatively, erroneously indicates a location that is not associated with a reference frame. Because advertisement signaling and reference frames can arrive at different packager instances and/or at different times, caching metadata until processing of a given segment is complete in the manner described helps to avoid race conditions.

At least one technical advantage of the disclosed techniques relative to the prior art is that mismatches and/or misalignments between advertisement signaling and reference frames can be detected and mitigated, thereby enabling situations to be avoided where such mismatches complicate or prevent transitioning between advertisements and primary content. Another technical advantage of the disclosed techniques is that detecting such mismatches downstream of the one or more encoders allows encoder defects to be addressed by the encoders expeditiously.

These technical advantages provide one or more technological advancements over prior art approaches.

### System Overview

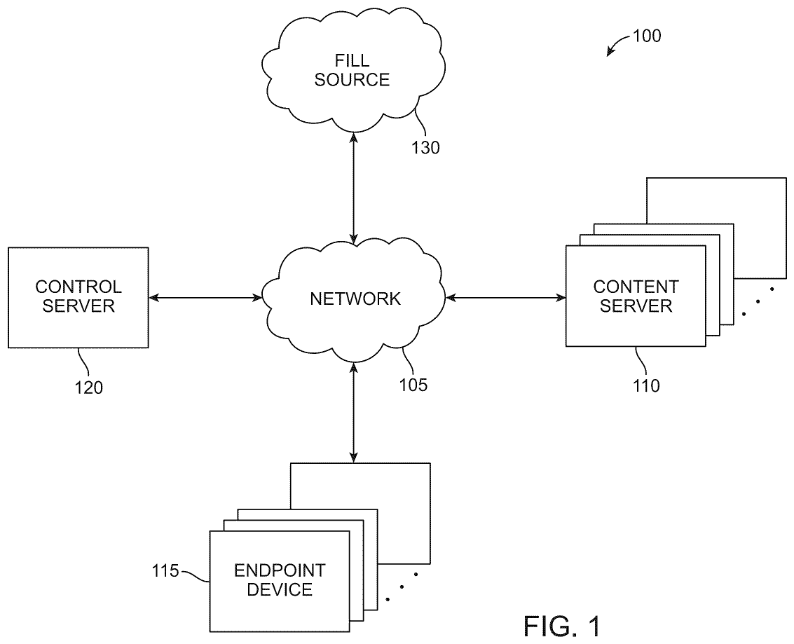

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

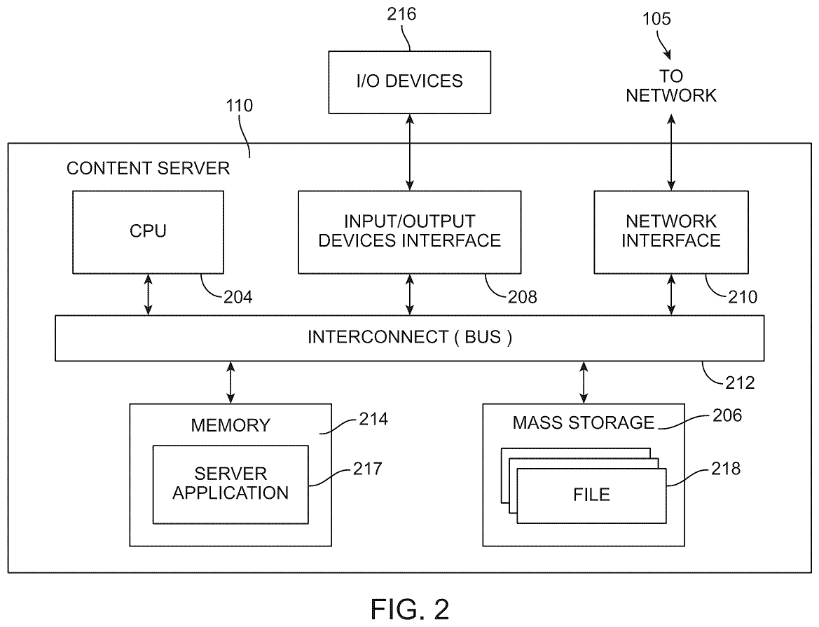

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a mass storage 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

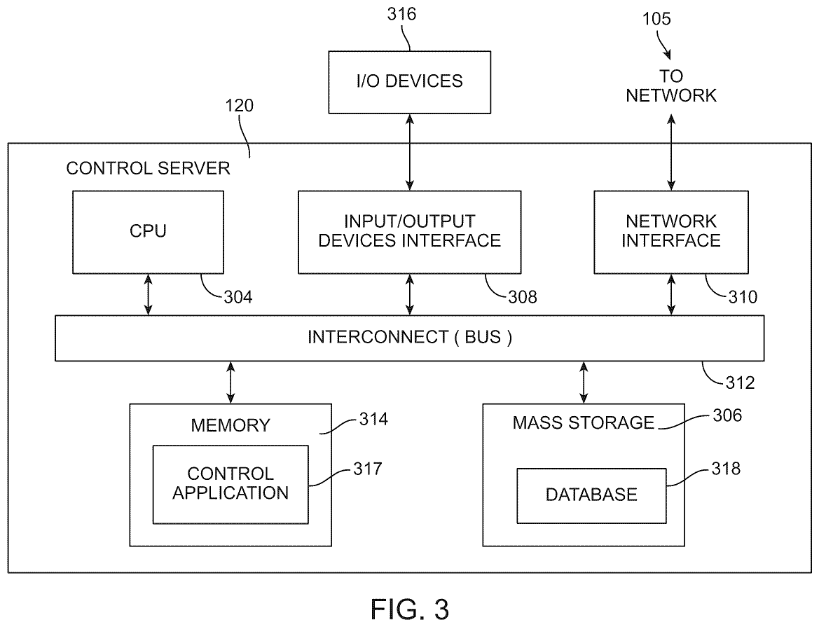

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a mass storage 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, I/O devices interface 308, the network interface 310, and the system memory 314. The I/O devices interface 308 is configured to transmit input data and output data between the I/O devices 316 and the CPU 304 via the interconnect 312. The mass storage 306 may include one or more hard disk drives, solid state storage devices, and the like. The mass storage 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within system 100, prior to storage.

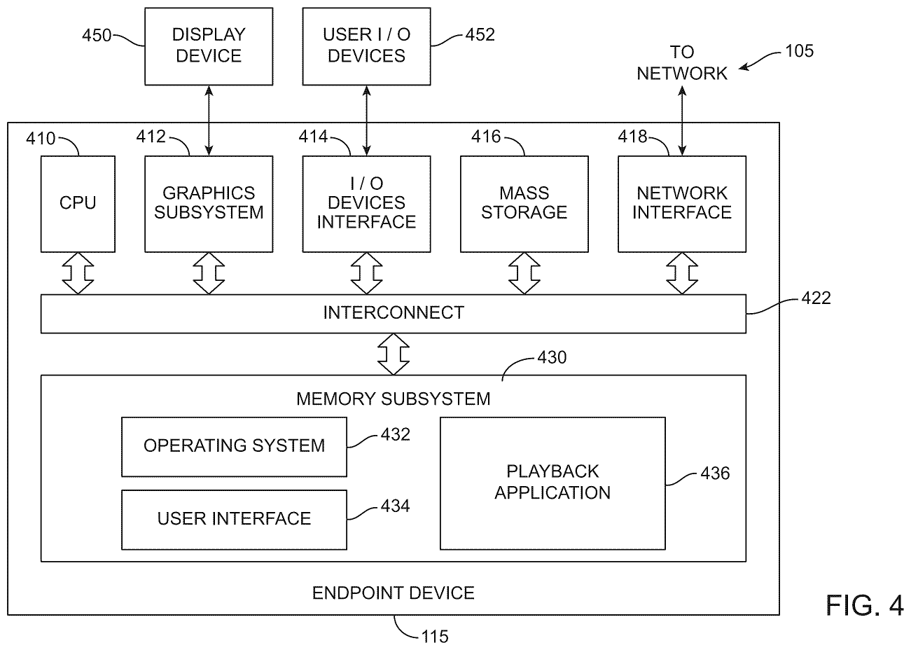

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline that decodes compressed content prior to display via display device.

### Detecting Reference Frame Mismatches in Encoded Video Streams

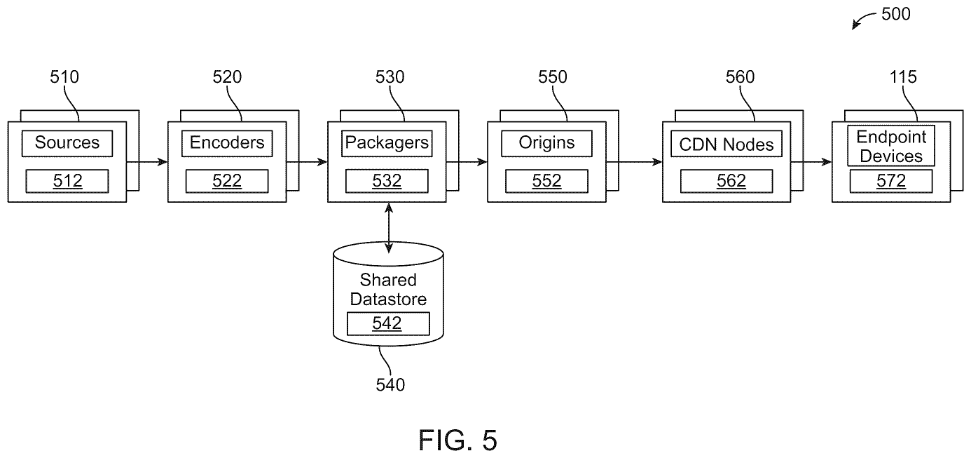

FIG. 5 illustrates a network infrastructure that can be used to distribute audiovisual content to the endpoint devices of FIG. 1, according to various embodiments. As shown, a network infrastructure 500 includes one or more sources 510, one or more encoders 520, one or more packagers 530 coupled to a shared datastore 540, one or more origins 550, one or more content delivery network (CDN) nodes 560, and one or more endpoint devices 115. The network infrastructure 500 is configured to generate, process, and distribute segments of audiovisual content to endpoint devices 115, where a given segment of audiovisual content includes one or more frames of audiovisual data. In various embodiments, a segment may correspond to a two-second duration of audiovisual content.

The network infrastructure 500 may form any technically feasible portion of, or extension to, the network infrastructure 100 shown in FIG. 1. Further, various components of the network infrastructure 500 can be implemented via the different components of the network infrastructure 100 described above in conjunction with FIGS. 1-4. In particular, in various embodiments, origins 550 may be implemented via one or more fill sources 130, and/or CDN nodes 560 may be implemented via one or more content servers 110. Various components of the network infrastructure 100 and/or network infrastructure 500 may form a portion of a control plane, such as the control server 120, for example and without limitation, while other components of the network infrastructure 100 or network infrastructure 500 may form a portion of a data plane, such as the origins 530, for example and without limitation.

In operation, the sources 510 store raw frames 512 of audiovisual content corresponding to a library of different media titles. Those media titles can be previously recorded, or, in some cases, correspond to live events that are occurring in real time. The sources 510 distribute the raw frames 512 of audiovisual content to the encoders 520. Upon receipt of the raw frames 512 of audiovisual content, the encoders 520 encode the raw frames of audiovisual content into encoded frames 522 of audiovisual content and provide these encoded frames 522 to the packagers 530 via one or more encoded video streams. The packagers 530 perform various packaging operations to prepare the encoded frames 522 for downstream decoding and output by endpoint devices 115, thereby generating packaged frames 532 of audiovisual content. As a general matter, the various frames of audiovisual content described herein correspond to different segments of a given media title, where a given segment includes one or more frames of audiovisual content. As described in greater detail below, the packagers 530 also cache various metadata 542 in the shared datastore 540 that can be used to detect mismatches and/or misalignment between advertisement signaling and reference frames.

The packagers 530 transmit the packaged frames 532 to origins 552, which provide location-based storage of packaged frames 532 as compressed objects 552. The origins 550 distribute the compressed objects 552 to the CDN nodes 562. The CDN nodes 562 are geographically distributed at edge locations proximate to different endpoint devices 115 and are configured to store cached objects 562 representing different copies of compressed objects 552. Upon request, one or more CDN nodes 562 transmit one or more cached objects 562 to endpoint devices 115 in order to support the streaming of media titles. A given endpoint device 115 performs a decoding operation with the received object(s) to generate decoded frames 572 of audiovisual content. Decoded frames 572 of audiovisual content can then be output to the user.

In various embodiments, multiple sources 510 are coupled to multiple downstream encoders 520, multiple encoders 520 are coupled to multiple downstream packagers 530, multiple packagers 530 are coupled to multiple downstream origins 550, multiple origins 550 are coupled to multiple downstream CDN nodes 560, and multiple CDN nodes 560 are coupled to multiple downstream endpoint devices 115, forming a distributed content generation and distribution system. In one embodiment, the network infrastructure 500 may process segments of audiovisual content having a fixed duration, such as two seconds, for example and without limitation. In this configuration, any given segment of audiovisual content may include portions of one or more video streams and/or portions of one or more audio streams that are processed by successive components of the network infrastructure 500. Further, any given component of the network infrastructure 500 may be configured to complete all processing operations associated with any given segment within a time frame that is proportional to the fixed duration of each segment. As mentioned above, a segment of audiovisual content generally includes one or more frames.

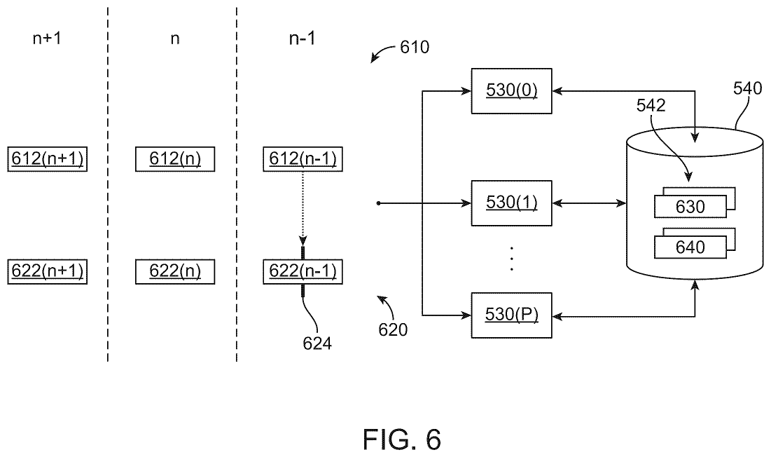

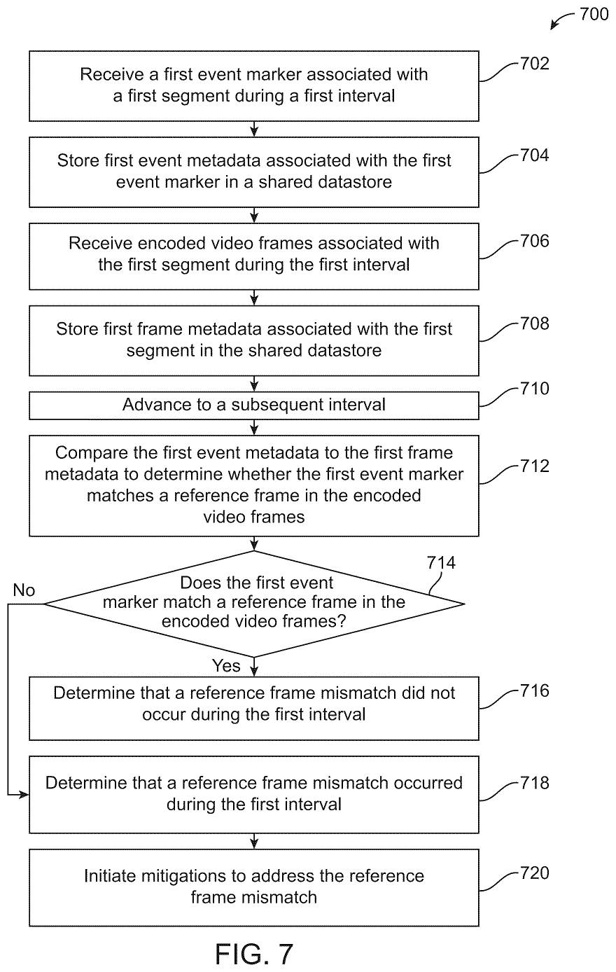

During streaming, various components of the network infrastructure 500 may coordinate operations in order to facilitate the insertion of audiovisual content associated with advertisements into the primary audiovisual content associated with a given media title. In one embodiment, components of the network infrastructure 500 may implement a server-guided advertisement insertion (SGAI) design, whereby an upstream component provides advertisement signaling that indicates specific reference frames in encoded audiovisual content where transitions between primary content and advertisement content can occur. Under various circumstances, advertisement signaling can erroneously indicate frame locations associated with non-reference frames or frame locations that otherwise do not correspond to a reference frame. Such situations are referred to herein as “reference frame mismatches” because the advertisement signaling does not match a particular, expected reference frame. The packagers 530 are configured to detect reference frame mismatches using techniques described in greater detail below in conjunction with FIGS. 6-7.

FIG. 6 illustrates how the packager of FIG. 5 detects reference frame mismatches in encoded video streams, according to various embodiments. As shown, packagers 530(0) and 530(1) through 530(P) are coupled to the shared datastore 540. The shared datastore 540 is a key-value caching mechanism that can be read from and written to by each packager 530.

In the example shown, without limitation, the packagers 530 receive streams 600 of audiovisual content associated with various segments that generally correspond to different intervals n+1, n, and n−1. In particular, the packagers 530 receive an event track 610 that includes event segments 612(n+1), 612(n), and 612(n−1) corresponding to intervals n+1, n, and n−1, respectively. Similarly, the packagers 530 receive video stream 620 that includes encoded video frames 622(n+1), 622(n), and 622(n−1) corresponding to intervals n+1, n, and n−1 respectively. As a general matter, an event segment 612 and encoded video frames 622 associated with a particular interval also correspond to a specific segment. For example, and without limitation, the event segment 612(n−1) and the encoded video frames 622(n−1) both correspond to a segment that is received and/or processed by the packagers 530 at or during interval n−1. In one embodiment, any number of event segments 612 and/or any number of encoded video frames 622 may correspond to any given segment.

A given event segment 612 can include advertisement signaling in the form of event markers that potentially indicate a reference frame included in encoded video frames 622 where content associated with an advertisement can begin or end, thereby representing a transition point between primary content and advertisement content. In the example shown, without limitation, event segment 612(n−1) includes event marker 614 that indicates reference frame 624 included in encoded video frames 622(n−1).

Reference frame 624 represents a location in the video stream 620 where the primary content associated with a media title being streamed can transition into content associated with an advertisement or, conversely, the content associated with an advertisement can transition back to the primary content. In the former case, reference frame 624 represents the first frame of the advertisement content. In the latter case, the reference frame 624 represents the first frame of the portion of the primary content immediately following the advertisement content.

Including advertisement signaling in the manner shown generally corresponds to the server-guided advertisement insertion (SGAI) design mentioned above. In one embodiment, Society of Cable Telecommunications Engineers (SCTE) 35 markers may be used to implement advertisement signaling included in event segments 612. In another embodiment, advertisement signaling may be included in a timed metadata track rather than event track 610. In various embodiments, advertisement signaling may be provided during a pre-roll period that occurs in advance of a particular reference frame where advertisement insertion is scheduled to occur and may continue for the duration of the content associated with the advertisement.

Under various circumstances, a given event segment 612 can include an event marker that erroneously indicates a reference frame in encoded video frames 622. In particular, an event marker can indicate a frame location that should be associated with a reference frame but is actually not associated with a reference frame and/or instead associated with a non-reference frame. Situations of this nature are referred to herein as “reference frame mismatches” because the event marker does not match an expected reference frame. The circumstances that lead to reference frame mismatches can arise due to encoder defects, among other causes, and can complicate and/or prevent transitions between advertisement content and primary content. In FIG. 6, a reference frame mismatch would occur if reference frame 624 was missing from encoded video frames 622(n−1) and potentially included in other encoded video frames 622.

Reference frame mismatches cannot easily be detected during a relevant interval for at least two reasons. First, due to the distributed configuration of the packagers 530, an event segment 612 and corresponding encoded video frames 622 sometimes arrive at different packagers 530 for processing. In the example shown, event segment 612(n−1) could arrive at packager 530(0) and encoded video frames 622(n−1) could arrive at packager 530(1). Second, due to the streaming operation of the network infrastructure 500, an event segment 612 and corresponding encoded video frames 622 can arrive at any given packager 530 according to an arbitrary ordering. Continuing the above example, event segment 612(n−1) could arrive at packager 530(0) before encoded video frames 622(n−1) arrive at packager 530(1) or, alternatively, after encoded video frames 622(n−1) arrive at packager 530(1).

Consequently, detecting reference frame mismatches involves analyzing various data that can reside at uncertain locations at uncertain times.

To facilitate the detection of reference frame mismatches given the issues mentioned above, packagers 530 are configured to store metadata 542 associated with streams 600. Metadata 542 includes event metadata 630 derived from event track 610 and frame metadata 640 derived from video stream 620. When a given packager 530 receives an event segment 612 that includes an event marker, such as event marker 614, the packager 530 updates event metadata 630 to include the event marker and/or a frame location indicated by the event marker that should correspond to a reference frame. In one embodiment, the packager 530 may also update the event metadata 630 to reflect that an event marker was not received. Similarly, when a given packager 530 receives encoded video frames 622 that includes a reference frame, such as reference frame 624, the packager 530 updates the frame metadata 640 to include the reference frame and/or a frame location corresponding to the reference frame. In one embodiment, the packager 530 may also update the frame metadata 640 to reflect that a reference frame was not received.

During a subsequent interval, any given packager 530 can inspect the shared datastore 540 and compare event metadata 630 to frame metadata 640 to determine whether a previously received event marker correctly indicates an existing reference frame included in previously received encoded video frames or, instead, erroneously indicates a missing reference frame. In the latter case, a reference frame mismatch is identified and the packager 530 notifies other components of the network infrastructure 500, such as the encoders 520, that the reference frame mismatch needs to be investigated. In one embodiment, the packager 530 may generate metrics that can be used to debug encoder defects.

The approach described above facilitates the detection of reference frame mismatches despite the distributed and asynchronous nature of the network infrastructure 100 because caching metadata 542 in the shared datastore during a given interval co-locates and collects all relevant data needed for detecting reference mismatches during a subsequent interval and/or during processing of a subsequent segment. This approach helps to avoid race conditions that can occur if event markers received during a given interval were attempted to be matched, during that same interval, against reference frames that may not be available yet.

Persons skilled in the art will understand that the techniques disclosed herein are applicable to any technically feasible division of processing tasks and are not limited to divisions based on interval, as described herein. For example, and without limitation, segments of audiovisual data could traverse the network infrastructure 500 grouped according to a segment index that may or may not directly correspond to a particular interval, point in time, or time span. In such cases, inspection of the shared datastore 540 to detect reference frame mismatches associated with one segment could occur during processing of a subsequent segment, irrespective of any specific interval.

In various embodiments, a given packager 530 may initiate a comparison between event metadata 630 and frame metadata 640 in response to receiving an event segment 612 that includes an event marker. In some configurations, multiple sequential event segments 612 may include event markers both leading up to a splice point where advertisement content can be inserted and, additionally, continuing for the duration of the advertisement content. In such cases, an event marker received in advance of the splice point (e.g., during a pre-roll period) may indicate the specific reference frame, but the packager 530 need only inspect the shared datastore 540 to compare event metadata 630 to frame metadata 640 after the specific reference frame is expected to arrive (e.g., during the subsequent interval and/or processing of the subsequent segment). In one embodiment, packagers 530 may specifically identify situations where a reference frame aligns with a segment boundary and refrain from reporting a reference frame mismatch if an additional reference frame is not found. In such cases, an additional reference frame is not needed because the segment boundary generally includes a reference frame. Persons skilled in the art will understand how the techniques described herein can be applied to detecting reference frame mismatches associated with either the start or end of any technically feasible alternative content, including but not limited to advertisement content.

FIG. 7 is a flow diagram of method steps for detecting reference frame mismatches in encoded video streams, according to various embodiments. Although the method steps are described in conjunction with the systems of FIGS. 1-6, persons skilled in the art will understand that any system configured to perform the method steps, in any order, is within the scope of the present invention.

As shown, a method 700 begins at step 702, where one of the packagers 530 receives a first event marker associated with a first segment during a first interval. The packagers 530 collectively operate as a distributed system and perform packaging operations with encoded audiovisual content to prepare that content for output across different endpoint devices 115. A given packager 530 may receive event segments included in an event track that corresponds to encoded video frames included in a video stream. In one embodiment, the first event marker may be implemented via a SCTE35 marker. At step 704, the packager 530 stores first event metadata associated with the first event marker in the shared datastore 540. The shared datastore 540 is accessible by each of the packagers 530 and, in various embodiments, may be implemented as a key-value store. The packager 530 may store the first event marker itself in the shared datastore 540 or generate metadata including a subset of the information included in the first event marker.

At step 706, one of the packagers 530 receives encoded video frames associated with the first segment during the first interval. Because the packagers 530 operate as a distributed system, the packager 530 that receives the first event marker at step 702 is not necessarily the same packager 530 that receives the encoded video frames at step 706. At step 708, the packager 530 stores first frame metadata associated with the first segment in the shared data store. The first frame metadata generally includes information that indicates a frame location associated with any reference frames included in the first segment. The packager 530 may store one or more reference frames themselves in the shared datastore 540 or generate metadata including a subset of the information included in those reference frames.

At step 710, the network infrastructure 500 advances to a subsequent interval. In one embodiment, the network infrastructure 500 may process segments of audiovisual data having a fixed duration, such as two seconds, for example and without limitation. Persons skilled in the art will understand that the techniques disclosed herein are applicable to any technically feasible division of processing tasks and are not limited to divisions based on interval, as described herein.

At step 712, one of the packagers 530 compares the first event metadata to the first frame metadata to determine whether the first event marker matches a reference frame in the encoded video frames. In one embodiment, the packager 530 that performs step 712 initiates the comparison of metadata in response to receiving an event segment that includes an event marker. At step 714, the packager 530 determines whether the first event marker matches a reference frame included in the encoded video frames.

If the packager 530 determines at step 714 that the first event marker matches a reference frame included in the encoded video frames, then the method proceeds to step 716. At step 716, the packager 530 determines that a reference frame mismatch did not occur during the first interval. Under nominal operating conditions the method 700 ends at step 716 and may repeat as needed in response to additionally received event segments and/or encoded video frames.

If the packager 530 determines at step 718 that the first event marker does not match a reference frame included in the encoded video frames, then the method proceeds to step 718. At step 718, the packager 530 determines that a reference frame mismatch occurred during the first interval. At step 720, the packager 530 initiates investigations to address the reference frame mismatch. In one embodiment, the packager 530 notifies the encoders 520 of a potential encoder defect and/or generates metrics that describe the potential encoder defects.

Because the packagers 530 operate as a distributed system, the various steps of the method 700 may be performed by different packagers 530, such as packagers 530(0), 530(1), and 530(P) shown in FIG. 5. However, as a general matter, steps 702 and 704 are performed by one packager 530, steps 706 and 708 are performed by one packager 530, and steps 712, 714, 716, 718, and 720 are performed by one packager 530.

In sum, one or more packager instances are coupled downstream of one or more encoder instances and are configured to detect mismatches and/or misalignment between advertisement signaling and reference frames included in segments of encoded video frames. Each packager instance is coupled to a shared datastore and is configured to cache metadata that is associated with received advertisement signaling and metadata associated with reference frames in the shared datastore during processing of a given segment. During processing of a subsequent segment, a given packager instance can inspect the shared datastore to determine whether advertisement signaling received during processing of the previous segment correctly indicates a reference frame included in the previous segment or, alternatively, erroneously indicates a location that is not associated with a reference frame. Because advertisement signaling and reference frames can arrive at different packager instances and/or at different times, caching metadata until processing of a given segment is complete in the manner described helps to avoid race conditions.

At least one technical advantage of the disclosed techniques relative to the prior art is that mismatches and/or misalignments between advertisement signaling and reference frames can be detected and mitigated, thereby enabling situations to be avoided where such mismatches complicate or prevent transitioning between advertisements and primary content. Another technical advantage of the disclosed techniques is that detecting such mismatches downstream of the one or more encoders allows encoder defects to be addressed by the encoders expeditiously.

These technical advantages provide one or more technological advancements over prior art approaches.
1. Various embodiments include a computer-implemented method for mitigating reference frame mismatches in encoded video streams, the method comprising generating first metadata that indicates a first frame location associated with a first encoded video stream, determining that the first encoded video stream includes a non-reference frame at the first frame location, and generating one or more metrics that describe a defect associated with at least a portion of the encoded video stream.
2. The computer-implemented method of clause 1, further comprising generating second metadata that indicates one or more reference frames included in the first encoded video stream, wherein determining that the first encoded video stream includes the non-reference frame at the first frame location comprises determining that the second metadata does not include a reference frame corresponding to the first frame location.
3. The computer-implemented method of any of clauses 1-2, further comprising generating second metadata that indicates a second frame location associated with a reference frame included in the encoded video stream, and determining that the first encoded video stream includes the reference frame at the second frame location.
4. The computer-implemented method of any of clauses 1-3, further comprising receiving a first event segment included in a first event track that corresponds to the first encoded video stream, wherein the first event segment includes a first event marker that indicates the first frame location, and wherein the first metadata is generated in response to receiving the first event segment.
5. The computer-implemented method of any of clauses 1-4, wherein the first frame location represents a transition point for transitioning from primary content included in the encoded video stream to secondary content associated with one or more advertisements.
6. The computer-implemented method of any of clauses 1-5, wherein the first frame location represents a transition point for transitioning from secondary content associated with one or more advertisements to primary content included in the

### Encoded Video Stream.

7. The computer-implemented method of any of clauses 1-6, wherein the first metadata is generated during a first time interval and the first encoded video stream is determined to include the non-reference frame during a subsequent time interval.
8. The computer-implemented method of any of clauses 1-7, wherein the non-reference frame cannot be decoded without a corresponding reference frame, and the corresponding reference frame can be decoded without the non-reference frame.
9. The computer-implemented method of any of clauses 1-8, wherein a first packager instances generates the first metadata and stores the first metadata in a shared datastore, and a second packager instance determines that the first encoded video stream includes the non-reference frame at the first frame location based on second metadata stored in the shared datastore.
10. The computer-implemented method of any of clauses 1-9, wherein determining that the first encoded video stream includes the non-reference frame at the first frame location occurs in response to receiving one or more event markers that indicate the first frame location.
11. Various embodiments include one or more non-transitory computer-readable media including instructions that, when executed by one or more processors, cause the one or more processors to mitigate reference frame mismatches in encoded video streams by performing the steps of generating first metadata that indicates a first frame location associated with a first encoded video stream, determining that the first encoded video stream includes a non-reference frame at the first frame location, and generating one or more metrics that describe a defect associated with at least a portion of the encoded video stream.
12. The one or more non-transitory computer-readable media of clause 11, further comprising the step of generating second metadata that indicates one or more reference frames included in the first encoded video stream, wherein the step of determining that the first encoded video stream includes the non-reference frame at the first frame location comprises determining that the second metadata does not include a reference frame corresponding to the first frame location.
13. The one or more non-transitory computer-readable media of any of clauses 11-12, further comprising the steps of generating second metadata that indicates a second frame location associated with a reference frame included in the encoded video stream, and determining that the first encoded video stream includes the reference frame at the second frame location.
14. The one or more non-transitory computer-readable media of any of clauses 11-13, wherein the first frame location represents a transition point for transitioning from primary content included in the encoded video stream to secondary content associated with one or more advertisements.
15. The one or more non-transitory computer-readable media of any of clauses 11-14, wherein the first frame location represents a transition point for transitioning from secondary content associated with one or more advertisements to primary content included in the encoded video stream.
16. The one or more non-transitory computer-readable media of any of clauses 11-15, wherein the first metadata is generated during a first time interval and the first encoded video stream is determined to include the non-reference frame during a subsequent time interval.
17. The one or more non-transitory computer-readable media of any of clauses 11-16, wherein a first packager instances generates the first metadata and stores the first metadata in a shared datastore, and a second packager instance determines that the first encoded video stream includes the non-reference frame at the first frame location based on second metadata stored in the shared datastore.
18. The one or more non-transitory computer-readable media of any of clauses 11-17, wherein the encoded video stream corresponds to a live event occurring in real time.
19. The one or more non-transitory computer-readable media of any of clauses 11-18, wherein the first metadata is generated based on a Society of Cable and Telecommunication Engineers 35 marker that indicates the first frame location.
20. Various embodiments include a system comprising one or more memories storing instructions, and one or more processors coupled to the one or more memories that, when executing the instructions, perform the steps of generating first metadata that indicates a first frame location associated with a first encoded video stream, determining that the first encoded video stream includes a non-reference frame at the first frame location, and generating one or more metrics that describe a defect associated with at least a portion of the encoded video stream.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. A computer-implemented method for mitigating reference frame mismatches in encoded video streams, the method comprising:
generating first metadata that indicates a first frame location associated with a first encoded video stream;
determining that the first encoded video stream includes a non-reference frame at the first frame location, wherein a non-reference frame is a frame that is decodable based at least on a reference frame; and
generating one or more metrics that describe a defect associated with at least a portion of the first encoded video stream.

2. The computer-implemented method of claim 1, further comprising generating second metadata that indicates one or more reference frames included in the first encoded video stream, wherein determining that the first encoded video stream includes the non-reference frame at the first frame location comprises determining that the second metadata does not include a reference frame corresponding to the first frame location.

3. The computer-implemented method of claim 1, further comprising:
generating second metadata that indicates a second frame location associated with a reference frame included in the first encoded video stream; and
determining that the first encoded video stream includes the reference frame at the second frame location.

4. The computer-implemented method of claim 1, further comprising receiving a first event segment included in a first event track that corresponds to the first encoded video stream, wherein the first event segment includes a first event marker that indicates the first frame location, and wherein the first metadata is generated in response to receiving the first event segment.

5. The computer-implemented method of claim 1, wherein the first frame location represents a transition point for transitioning from primary content included in the first encoded video stream to secondary content associated with one or more advertisements.

6. The computer-implemented method of claim 1, wherein the first frame location represents a transition point for transitioning from secondary content associated with one or more advertisements to primary content included in the first encoded video stream.

7. The computer-implemented method of claim 1, wherein the first metadata is generated during a first time interval and the first encoded video stream is determined to include the non-reference frame during a subsequent time interval.

8. The computer-implemented method of claim 1, wherein the non-reference frame cannot be decoded without a corresponding reference frame, and the corresponding reference frame can be decoded without the non-reference frame.

9. The computer-implemented method of claim 1, wherein a first packager instances generates the first metadata and stores the first metadata in a shared datastore, and a second packager instance determines that the first encoded video stream includes the non-reference frame at the first frame location based on second metadata stored in the shared datastore.

10. The computer-implemented method of claim 1, wherein determining that the first encoded video stream includes the non-reference frame at the first frame
location occurs in response to receiving one or more event markers that indicate the first frame location.

11. One or more non-transitory computer-readable media including instructions that, when executed by one or more processors, cause the one or more processors to mitigate reference frame mismatches in encoded video streams by performing the steps of:
generating first metadata that indicates a first frame location associated with a first encoded video stream;
determining that the first encoded video stream includes a non-reference frame at the first frame location, wherein a non-reference frame is a frame that is decodable based at least on a reference frame; and
generating one or more metrics that describe a defect associated with at least a portion of the first encoded video stream.

12. The one or more non-transitory computer-readable media of claim 11, further comprising the step of generating second metadata that indicates one or more reference frames included in the first encoded video stream, wherein the step of determining that the first encoded video stream includes the non-reference frame at the first frame location comprises determining that the second metadata does not include a reference frame corresponding to the first frame location.

13. The one or more non-transitory computer-readable media of claim 11, further comprising the steps of:
generating second metadata that indicates a second frame location associated with a reference frame included in the first encoded video stream; and
determining that the first encoded video stream includes the reference frame at the second frame location.

14. The one or more non-transitory computer-readable media of claim 11, wherein the first frame location represents a transition point for transitioning from primary content included in the first encoded video stream to secondary content associated with one or more advertisements.

15. The one or more non-transitory computer-readable media of claim 11, wherein the first frame location represents a transition point for transitioning from secondary content associated with one or more advertisements to primary content included in the first encoded video stream.

16. The one or more non-transitory computer-readable media of claim 11, wherein the first metadata is generated during a first time interval and the first encoded video stream is determined to include the non-reference frame during a subsequent time interval.

17. The one or more non-transitory computer-readable media of claim 11, wherein a first packager instances generates the first metadata and stores the first metadata in a shared datastore, and a second packager instance determines that the first encoded video stream includes the non-reference frame at the first frame location based on second metadata stored in the shared datastore.

18. The one or more non-transitory computer-readable media of claim 11, wherein the first encoded video stream corresponds to a live event occurring in real time.

19. The one or more non-transitory computer-readable media of claim 11, wherein the first metadata is generated based on a Society of Cable and Telecommunication Engineers 35 marker that indicates the first frame location.

20. A system comprising:
one or more memories storing instructions; and
one or more processors coupled to the one or more memories that, when executing the instructions, perform the steps of:
generating first metadata that indicates a first frame location associated with a first encoded video stream,
determining that the first encoded video stream includes a non-reference frame at the first frame location, wherein a non-reference frame is a frame that is decodable based at least on a reference frame, and
generating one or more metrics that describe a defect associated with at least a portion of the first encoded video stream.
